(19) United States
(12) Patent Application Publication
(10) Pub. No.: US 2019/0147058 A1
(43) Pub. Date: May 16, 2019

(54) METHOD AND APPARATUS FOR PUSHING MULTIMEDIA CONTENT

(71) Applicant: Baidu Online Network Technology (Beijing) Co., Ltd., Beijing (CN)

(72) Inventors: Guang LU, Beijing (CN); Shiquan YE, Beijing (CN); Xiajun LUO, Beijing (CN); Ming WANG, Beijing (CN)

(21) Appl. No.: 15/856,785

(22) Filed: Dec. 28, 2017

(30) Foreign Application Priority Data
Nov. 16, 2017 (CN) 201711139658.0

(51) Int. Cl. G06F 17/30; H04L 29/08; G10L 15/22; G10L 25/63

(52) U.S. Cl. CPC G06F 17/30029; G06F 17/3002; G06F 17/3053; G10L 2015/223; H04L 67/26; G10L 15/22; G10L 25/63; G06F 17/30528

(57) ABSTRACT

The embodiments of the disclosure disclose a method and apparatus for pushing multimedia content. An embodiment of the method includes: determining, in response to receiving a request for playing multimedia content, application scenario information for indicating an application scenario where a multimedia playing terminal is located; determining the multimedia content matching the application scenario from a multimedia content database, and adding the multimedia content to a candidate multimedia content set, the multimedia content database including a scenario index pre-established based on an application scenario; filtering the candidate multimedia content set to obtain a recommended multimedia content set; and pushing the recommended multimedia content set to the multimedia playing terminal. The embodiment realizes pushing multimedia contents with pertinence.

### CROSS-REFERENCE TO RELATED APPLICATION

This application is related to and claims priority from Chinese Application No. 201711139658.0, filed on Nov. 16, 2017, entitled “Method and Apparatus for Pushing Multimedia Content,” having Baidu Online Network Technology (Beijing) Co., Ltd. as the applicant, the entire disclosure of which is incorporated herein by reference.

### TECHNICAL FIELD

The disclosure relates to the field of computer technology, specifically to the field of internet technology, and more specifically to a method and apparatus for pushing multimedia content.

### BACKGROUND

Information push, also known as “network broadcast,” is a technology that reduces information overload by pushing information desired by a user on the Internet through certain technical standards or protocols. The information push technology may reduce the time spent by a user in search on the Internet by actively pushing information to the user.

An existing multimedia platform may generate a playlist of all multimedia contents of the platform by interacting with users.

For example, a user may get access to a multimedia platform application, and generate a multimedia content playlist by inputting some search conditions, where multimedia contents in the multimedia content playlist are all provided by the multimedia platform. This way, the user may implement corresponding operations, such as playing and pausing, of the multimedia contents in the multimedia content playlist.

How to apply the information push technology in a multimedia platform, to enable pushing multimedia contents to the users to be more accurate and meet users' expectations, becomes a problem in urgent need of solution.

### SUMMARY

An object of an embodiment of the disclosure is to provide a method and apparatus for pushing multimedia content.

In a first aspect, an embodiment of the disclosure provides a method for pushing multimedia content, including: determining, in response to receiving a request for playing multimedia content, application scenario information for indicating an application scenario where a multimedia playing terminal is located; determining the multimedia content matching the application scenario from a multimedia content database, and adding the multimedia content to a candidate multimedia content set, the multimedia content database including a scenario index pre-established based on an application scenario; filtering the candidate multimedia content set to obtain a recommended multimedia content set; and pushing the recommended multimedia content set to the multimedia playing terminal.

In some embodiments, the application scenario information includes application environment information, and the application environment information includes at least one of following information items: information for indicating a current moving speed of the multimedia playing terminal; information for indicating current time; information for indicating current weather; and information for indicating a current hot event.

In some embodiments, the application scenario information includes current state information of a user using the multimedia playing terminal, and the request for playing multimedia content includes voice request information inputted by the user; and the determining, in response to receiving a request for playing multimedia content, application scenario information for indicating an application scenario where a multimedia playing terminal is located comprises: analyzing the voice request information inputted by the user to determine a voice characteristic of the voice request information inputted by the user; and determining the current state information for indicating a current state of the user using the multimedia playing terminal based on the voice characteristic.

In some embodiments, the current state information includes at least one of the following information items: information for indicating a current mood of the user; and information for indicating an age of the user.

In some embodiments, the request for playing multimedia content includes attribute information for indicating an attribute of the multimedia content; the multimedia content database has an attribute index pre-established based on the attribute information of the multimedia content; and the filtering the candidate multimedia content set to obtain a recommended multimedia content set includes: filtering multimedia contents comprised in the candidate multimedia content set based on at least one attribute information indicated by a user preference, wherein the user preference is determined based on a historical operation behavior of the user.

In some embodiments, before pushing the recommended multimedia content set to the multimedia playing terminal, the method further includes: determining multimedia content matching associated multimedia content of the user from a multimedia content database, wherein the associated multimedia content of the user is multimedia content including a positive emotion operation executed thereon by the user; and adding the multimedia content matching the associated multimedia content of the user to the recommended multimedia content set.

In some embodiments, the determining multimedia content matching associated multimedia content of the user from a multimedia content database includes: determining the multimedia content matching the associated multimedia content of the user from the multimedia content database based on an approximate nearest neighbor search algorithm.

In some embodiments, after the filtering the candidate multimedia content set to obtain a recommended multimedia content set, the method further includes: ordering recommended multimedia contents for playing in the recommended multimedia content set based on an attenuation factor of the recommended multimedia contents for playing in the recommended multimedia content set; wherein the attenuation factor is determined based on at least one of following items: a number of playing times of each of the recommended multimedia contents in a predetermined historical period; and a playing moment of each of the recommended multimedia contents in a predetermined historical period.

In some embodiments, the filtering the candidate multimedia content set to obtain a recommended multimedia content set comprises: deleting multimedia content corresponding to a user emotionally negatively biased operation from the candidate multimedia content set.

In a second aspect, an embodiment of the disclosure provides an apparatus for pushing multimedia content, including: an application scenario determination unit configured for determining, in response to receiving a request for playing multimedia content, application scenario information for indicating an application scenario where a multimedia playing terminal is located; a candidate multimedia content generation unit, configured for determining the multimedia content matching the application scenario from a multimedia content database, and adding the multimedia content to a candidate multimedia content set, the multimedia content database including a scenario index pre-established based on an application scenario; a filtration unit, configured for filtering the candidate multimedia content set to obtain a recommended multimedia content set; and a pushing unit, configured for pushing the recommended multimedia content set to the multimedia playing terminal.

In some embodiments, the application scenario information includes application environment information, and the application environment information includes at least one of following information items: information for indicating a current moving speed of the multimedia playing terminal; information for indicating current time;

information for indicating current weather; and information for indicating a current hot event.

In some embodiments, the application scenario information includes current state information of a user using the multimedia playing terminal, and the request for playing multimedia content includes voice request information inputted by the user; and the application scenario determination unit is further configured for: analyzing the voice request information inputted by the user to determine a voice characteristic of the voice request information inputted by the user; and determining the current state information for indicating a current state of the user using the multimedia playing terminal based on the voice characteristic.

In some embodiments, the current state information includes at least one of the following information items: information for indicating a current mood of the user; and information for indicating an age of the user.

In some embodiments, the request for playing multimedia content includes attribute information for indicating an attribute of the multimedia content; the multimedia content database has attribute index pre-established based on the attribute information of the multimedia content; and the filtration unit is further configured for filtering multimedia contents comprised in the candidate multimedia content set based on at least one attribute information indicated by a user preference, wherein the user preference is determined based on a historical operation behavior of the user.

In some embodiments, the apparatus further includes: an associated multimedia matching unit, configured for determining, before the pushing unit pushes the recommended multimedia content set to the multimedia playing terminal, multimedia content matching associated multimedia content of the user from a multimedia content database, and adding the multimedia content matching the associated multimedia content of the user to the recommended multimedia content set; wherein the associated multimedia content of the user is multimedia content including a positive emotion operation executed thereon by the user.

In some embodiments, the associated multimedia matching unit is further configured for: determining the multimedia content matching the associated multimedia content of the user from the multimedia content database based on an approximate nearest neighbor search algorithm.

In some embodiments, the apparatus further includes: an ordering unit, configured for ordering recommended multimedia contents for playing in the recommended multimedia content set based on an attenuation factor of the recommended multimedia contents for playing in the recommended multimedia content set after the filtration unit filtering the candidate multimedia content set to obtain a recommended multimedia content set; wherein the attenuation factor is determined based on at least one of following items: a number of playing times of each of the recommended multimedia contents in a predetermined historical period; and a playing moment of each of the recommended multimedia contents in a predetermined historical period.

In some embodiments, the filtration unit is further configured for: deleting multimedia content corresponding to a user emotionally negatively biased operation from the candidate multimedia content set.

In a third aspect, an embodiment of the disclosure further provides a system, including: one or more processors; and a storage device for storing one or more programs; where the one or more programs, when executed by the one or more processors, enable the one or more processors to implement the method.

In a fourth aspect, an embodiment of the disclosure further provides a computer readable storage medium storing computer programs, where the programs, when executed by a processor, enable to implement the method.

A method and apparatus for pushing multimedia content provided in an embodiment of the disclosure determine, in response to receiving of a request for playing multimedia content, application scenario information for indicating an application scenario where a multimedia playing terminal is located, determine the multimedia content matching the application scenario from a multimedia content database, add the multimedia content to a candidate multimedia content set, filter the candidate multimedia content set to obtain a recommended multimedia content set; and push the recommended multimedia content set to the multimedia playing terminal, so that the finally obtained recommended multimedia content set is applicable to the application scenario of the current multimedia playing terminal, thus realizing pushing multimedia contents with pertinence.

### BRIEF DESCRIPTION OF THE DRAWINGS

By reading and referring to the detailed description of non-limiting embodiments provided in the accompanying drawings, other features, objects and advantages of the disclosure will become clearer:

FIG. 1 is an illustrative system structure diagram where the disclosure may be applied;

FIG. 2 is a process diagram of an embodiment of a method for pushing multimedia content according to the disclosure;

FIG. 3 is a schematic diagram of an application scenario of a method for pushing multimedia content according to the disclosure;

FIG. 4 is a process diagram of another embodiment of a method for pushing multimedia content according to the disclosure;

FIG. 5 is a structural diagram of an embodiment of an apparatus for pushing multimedia content according to the disclosure; and

FIG. 6 is a structural diagram of a computer system of a terminal device or a server applicable for implementing the embodiments of the disclosure.

### DETAILED DESCRIPTION OF EMBODIMENTS

The present application will be further described below in detail in combination with the accompanying drawings and the embodiments. It should be appreciated that the specific embodiments described herein are merely used for explaining the relevant disclosure, rather than limiting the disclosure. In addition, it should be noted that, for the ease of description, only the parts related to the relevant disclosure are shown in the accompanying drawings.

It should also be noted that the embodiments in the present application and the features in the embodiments may be combined with each other on a non-conflict basis. The present application will be described below in detail with reference to the accompanying drawings and in combination with the embodiments.

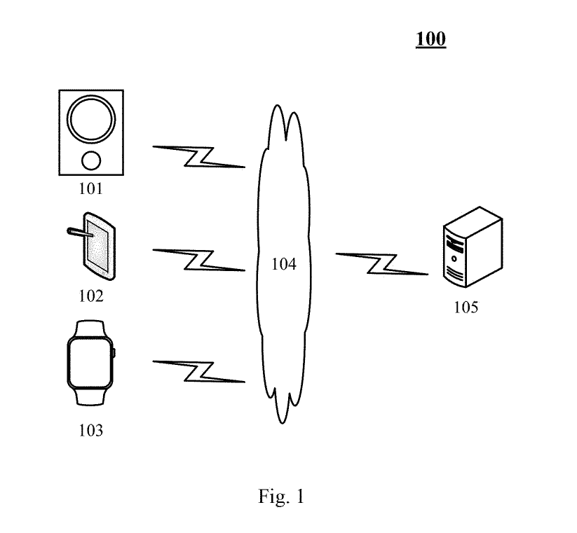

FIG. 1 shows an exemplary architecture of a system 100 which may be used by a method for pushing multimedia content or an apparatus for pushing multimedia content according to an embodiment of the present application.

As shown in FIG. 1, the system architecture 100 may include terminal devices 101, 102 and 103, a network 104 and a server 105. The network 104 serves as a medium providing a communication link between the terminal devices 101, 102 and 103 and the server 105. The network 104 may include various types of connections, such as wired or wireless transmission links, or optical fibers.

The user may use the terminal devices 101, 102 and 103 to interact with the server 105 through the network 104, in order to transmit or receive messages, etc. Various communication client applications, such as a multimedia playing application, a web browser application, a search application, an instant messaging tool and social platform software, may be installed on the terminal devices 101, 102 and 103.

The terminal devices 101, 102 and 103 may be electronic devices including a man-machine interaction function and a multimedia playing function, including but not limited to: a smart phone, a smart multimedia playing device, a smart wearable device, a tablet PC, a laptop portable computer, a desk computer, etc.

The server 105 may be a server providing a variety of services, such as background multimedia servers providing supports for multimedia playing requests sent by the terminal devices 101, 102 and 103. The background multimedia servers may implement analysis and other processing of the received data, such as a multimedia playing request, and send feedback of the processing result (such as the generated recommended multimedia content set) to the terminal terminals 101, 102 and 103.

It should be noted that the method for pushing multimedia content provided in the embodiments of the disclosure is generally executed by the server 105, and correspondingly, the apparatus for pushing multimedia content is generally installed on the server 105.

It should be appreciated that the numbers of the terminal devices, the networks and the servers in FIG. 1 are merely illustrative. Any number of terminal devices, networks and servers may be provided based on the actual requirements.

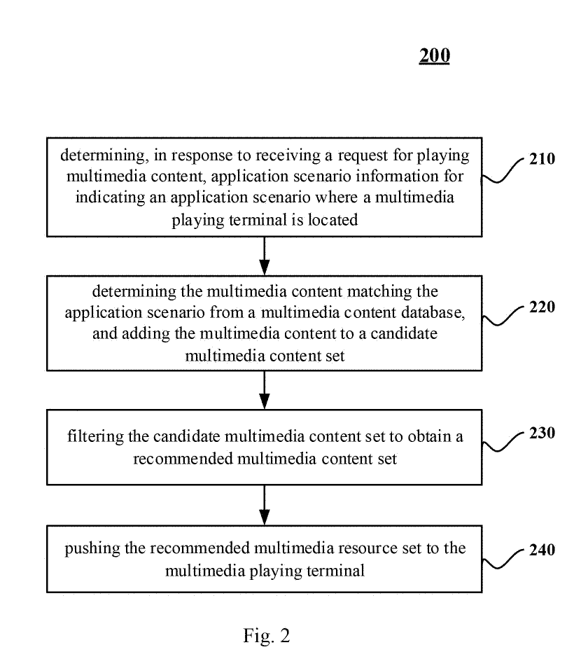

Further referring to FIG. 2, a process 200 of an embodiment of a method for pushing multimedia content according to the disclosure is shown. The method for pushing multimedia content includes the following steps:

In Step 210, application scenario information for indicating an application scenario where a multimedia playing terminal is located is determined in response to receiving a request for playing multimedia content.

In some application scenarios of this embodiment, an electronic device (e.g., a server shown in FIG. 1) on which the method for playing multimedia content runs may receive a request for playing multimedia content from a user using an access to a multimedia playing application through wired connection or wireless connection. In these application scenarios, the user may input the request for playing the multimedia content by operating a relevant widget of the multimedia playing application.

Alternatively, in some other application scenarios of this embodiment, the electronic device may also receive the request for playing multimedia content from a multimedia playing terminal that plays multimedia through wired connection or wireless connection. In these application scenarios, the multimedia playing terminal, e.g., may be integrated with a voice receiving module. A user may input a request for playing multimedia content into the voice receiving module by voice. After receiving the request for playing the multimedia content by voice, the multimedia terminal may analyze the voice inputted by the user using a locally integrated voice analysis module, and send the analysis result to the electronic device. Or, after receiving the request for playing the multimedia content by voice, the multimedia terminal may send the received voice to the electronic device, to enable the electronic device to implement relevant analysis operation after receiving the voice.

It should be noted that the wireless connection may include, but is not limited to, 3G/4G connection, WiFi connection, Bluetooth connection, WiMAX connection, Zigbee connection, UWB (ultra wideband) connection, and other wireless connections that are known at present or will be developed in the future.

Here, the application scenario information may be any information that may indicate current scenario and/or state of the multimedia playing terminal and/or the user using the multimedia playing terminal.

For example, in some application scenarios, the multimedia playing terminals of some models are specially used in vehicle-mounted environments. In these application scenarios, the electronic device on which the method for playing multimedia content according to this embodiment is applied may determine its application scenario based on the model of the multimedia playing terminal sending the multimedia playing request.

In Step 220, the multimedia content matching the application scenario from a multimedia content database is determined, and the multimedia content is added to a candidate multimedia content set, the multimedia content database including a scenario index pre-established based on an application scenario.

Here, the multimedia content database may be a database storing large amounts of multimedia contents. In some optional modes of implementing this embodiment, the database may be maintained by the electronic device on which the method for playing multimedia content according to this embodiment is applied. Or, in some other optional modes of implementing this embodiment, the database may also be a database in communication connection with the electronic device on which the method for playing multimedia content according to this embodiment is applied.

Because a multimedia content database has a scenario index pre-established based on an application scenario, after determining application scenario information of an application scenario where a multimedia playing terminal is located, the multimedia content matching the application scenario may be determined from a multimedia content database using the application scenario information as a search condition, and the multimedia contents are added to a candidate multimedia content set.

In Step 230, the candidate multimedia content set is filtered to obtain a recommended multimedia content set.

In some application scenarios, for example, a user seldom listens to or watches multimedia content performed or sung by a performer, so that it may be considered that the user has a low degree of preference for the performer. In these application scenarios, the multimedia contents may be filtered from the candidate multimedia content set generated in the step 220, and the multimedia contents performed or sung by a performer for whom a user has a low degree of preference may be deleted the candidate multimedia content set.

In Step 240, the recommended multimedia content set is pushed to the multimedia playing terminal.

The electronic device on which the method for playing multimedia content according to this embodiment runs may push a generated multimedia set recommended for playing to the multimedia playing terminal for playing by the multimedia playing terminal.

The method for pushing multimedia content provided in this embodiment realizes pushing multimedia contents with pertinence by: determining, in response to receiving a request for playing multimedia content, application scenario information for indicating an application scenario where a multimedia playing terminal is located; determining the multimedia content matching the application scenario from a multimedia content database, and adding the multimedia content to a candidate multimedia content set, the multimedia content database including a scenario index pre-established based on an application scenario; filtering the candidate multimedia content set to obtain a recommended multimedia content set; and pushing the recommended multimedia content set to the multimedia playing terminal.

In some optional modes of implementing this embodiment, the application scenario information may include application environment information, and the application environment information may include at least one of the following information items: information for indicating a current moving speed of the multimedia playing terminal; information for indicating current time; information for indicating current weather; and information for indicating a current hot event.

For example, in some application scenarios, the application environment information may include information for indicating current time. Thus, when receiving a user's request for playing multimedia content (for example, a user says “play some music” to a multimedia playing terminal), the electronic device on which the method for playing multimedia content according to this embodiment is applied may determine the multimedia content matching the current time from a multimedia content database. For example, the current time is 7 a.m., and the electronic device may determine the multimedia content suitable for listening in early morning from a multimedia content database. It is understandable that in these application scenarios, the multimedia content database has an index pre-established based on different intervals (for example, early morning, morning, noon, afternoon, evening and midnight) of the current time.

Alternatively, in some other application scenarios, the application environment information may include information for indicating current weather. Thus, when receiving a user's request for playing multimedia content (for example, a user says “play some music” to a multimedia playing terminal), the electronic device on which the method for playing multimedia content according to this embodiment is applied may determine the multimedia content matching the current weather from a multimedia content database. For example, the current weather is moderate rain, and the electronic device may determine multimedia content suitable for listening on rainy days from a multimedia content database. It is understandable that in these application scenarios, the multimedia content database has an index pre-established based on the current weather (e.g., sunny, windy, cloudy, rainy and snowy weather).

Alternatively, in some other application scenarios, the application environment information includes information for indicating a current hot event. Thus, when receiving a user's request for playing multimedia content (for example, a user says “play some music” to a multimedia playing terminal), the electronic device on which the method for playing multimedia content according to this embodiment is applied may determine the multimedia content matching the hot event from a multimedia content database. For example, the current hot event is that a singer Y will hold a concert this evening, and the electronic device may determine songs to be sung by the singer Y from a multimedia content database. It is understandable that in these application scenarios, the multimedia database has an index pre-established based on a hot event (for example, a singer indicated by a recent performance, and holidays and festivals contained in a recent period).

In some other optional modes of implementing this embodiment, the application scenario information may further include current state information of a user using the multimedia playing terminal. In these optional modes of implementing this embodiment, the request for playing multimedia content may include voice request information inputted by a user.

In these optional modes of implementing this embodiment, the step 210 of the method for pushing multimedia content according to this embodiment may further include:

Step 211, analyzing the voice request information inputted by the user to determine voice characteristics of the voice request information inputted by the user.

The voice characteristics, e.g., maybe parameters that can characterize voice features inputted by a user, for example, including but not limited to timbre, inherent frequency, speed and the like of voice.

In Step 212, the current state information for indicating a current state of the user using the multimedia playing terminal is determined based on the voice characteristics.

Here, the current state information, e.g., may include at least one of the following information items: information for indicating a current mood of a user; and information for indicating an age of the user.

For example, in some application scenarios, by analyzing user voice input to determine a user being currently in a “depressed” mood, the electronic device on which the method for playing multimedia content according to this embodiment is applied may obtain some multimedia contents including effects of alleviating and comforting the “depressed” mood by search in a multimedia content database, and add the multimedia contents obtained by search to a candidate multimedia content set.

Alternatively, in some application scenarios, by analyzing a user's voice input to determine the current user being a child, the electronic device on which the method for playing multimedia content according to this embodiment is applied may search multimedia contents suitable for a child in a multimedia content database, and add the multimedia contents obtained by search to a candidate multimedia content set.

Thus, by analyzing voice characteristics obtained by analyzing the user's voice input, the current state information of the user, such as current mood and/or age, may be determined, so as to push multimedia contents to the user using the multimedia playing terminal with more pertinence.

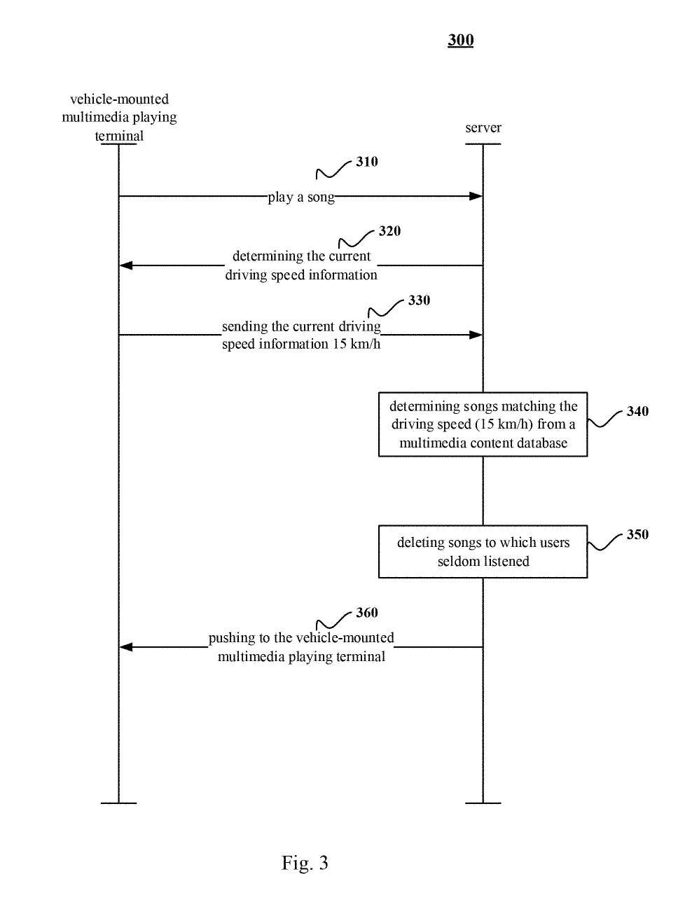

Referring to FIG. 3, a schematic diagram of an application scenario of a method for pushing multimedia content according to the disclosure is shown.

In this application scenario, illustrative description is provided by interaction between a multimedia playing terminal applied in a vehicle-mounted environment and an electronic device (e.g., a server 105 shown in FIG. 1) on which the method for playing multimedia content according to this embodiment is applied.

As shown by a reference number 310 in the figure, a user sends a voice “play a song” to the vehicle-mounted multimedia playing terminal.

Then, as shown by a reference number 320 in the figure, the server determines, upon receipt of the request for playing a song, the current driving speed information of the vehicle-mounted multimedia playing terminal. For example, a server may send a request for obtaining a driving speed to the vehicle-mounted multimedia playing terminal, so that a vehicle-mounted driving speed sensing device sends the driving speed information (e.g., 15 km/h) to the server through the vehicle-mounted multimedia playing terminal, as shown by a reference number 330 in the figure.

Then, as shown by a reference number 340 in the figure, the server determines songs matching the current driving speed (15 km/h) of the vehicle-mounted multimedia playing terminal from a multimedia content database, and adds the songs to a candidate multimedia content set. The multimedia content database has a scenario index pre-established based on an application scenario. For example, the multimedia content database has an index pre-established based on driving speed information. The driving speed of 15 km/h suggests that the current user is very likely to be in a traffic jam state. Under the circumstance, songs obtained by search from the multimedia content database, e.g., may be songs of slow rhythm and contributing to alleviating dysphoric mood of the user.

Then, as shown by a reference number 350 in the figure, a candidate multimedia content set is filtered, and songs to which the user seldom listens are deleted therefrom to obtain a recommended multimedia content set.

Then, as shown by a reference number 360 in the figure, the generated recommended multimedia content set is pushed to the vehicle-mounted multimedia terminal.

Furthermore, in some optional modes of implementing this embodiment, the request for playing multimedia content may include attribute information for indicating an attribute of the multimedia content; and correspondingly, the multimedia content database has an attribute index pre-established based on the attribute information of the multimedia content.

In some optional modes of implementing this embodiment, in a method for pushing multimedia content according to this embodiment, the filtering the candidate multimedia content set to obtain a recommended multimedia content set in the step 230 may further include:

Step 231, filtering multimedia contents included in the candidate multimedia content set based on at least one attribute information indicated by a user preference, wherein the user preference is determined based on a historical operation behavior of the user.

In these optional modes of implementing this embodiment, attribute information may be any information that can reflect characteristics of multimedia content. For example, the attribute information may include, but is not limited to, a name of multimedia content, a name of a leading author, a language, a style, emotion, and the like.

For example, in some application scenarios of these optional modes of implementing this embodiment, a user listens to rock songs of a singer A quite a lot before. Then, it may be considered that attribute information indicated by the user's preference may include the “singer A” and “rock music style”. Then, in the step 231, by filtering the generated candidate multimedia content set, songs of the singer A, or songs of rock music style therefrom, or rock songs of the singer A therefrom may be selected.

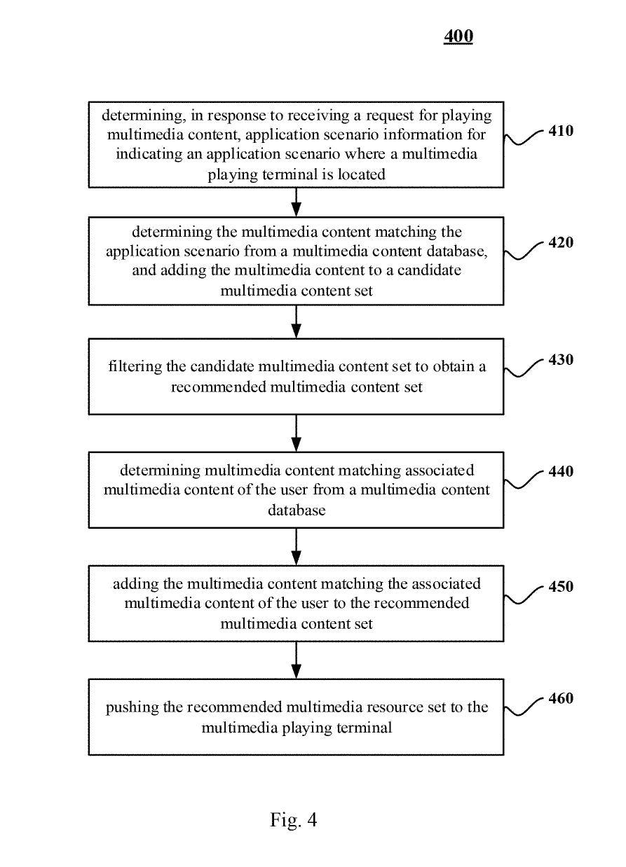

Referring to FIG. 4, an illustrative process diagram 400 of another embodiment of a method for pushing multimedia content according to the disclosure is shown. The method of the embodiment includes the following steps:

In Step 410, application scenario information for indicating an application scenario where a multimedia playing terminal is located is determined in response to receiving a request for playing multimedia content.

In Step 420, the multimedia content matching the application scenario from a multimedia content database is determined, and the multimedia content is added to a candidate multimedia content set, the multimedia content database including a scenario index pre-established based on an application scenario.

In Step 430, the candidate multimedia content set is filtered to obtain a recommended multimedia content set.

The step 410—the step 430 may have a mode of implementation similar to the step 210—the step 230 in the embodiment shown in FIG. 2, and are not repeated any more here.

In Step 440, multimedia content matching associated multimedia content of the user is determined from a multimedia content database, wherein the associated multimedia content of the user is multimedia content including a positive emotion operation executed thereon by the user.

For example, in some application scenarios, a user had executed a “thumb up” operation on song S1, and then it may be considered that the user likes the song S1, e.g., the user has a positive emotion for the song S1. In these application scenarios, a song matching the song S1, e.g., may be a song determined based on a similarity calculation method that has a similarity with the song S1 greater than a preset similarity threshold.

In Step 450, the multimedia content matching the associated multimedia content of the user is added to the recommended multimedia content set.

It may be considered that the multimedia content matching associated multimedia content of a user also has a high probability of being favoured by the user. Therefore, these multimedia contents are added to a recommended multimedia content set to enable the multimedia contents in the recommended multimedia content set to better satisfy the user's preference.

In Step 460, the recommended multimedia content set is pushed to the multimedia playing terminal.

The method for pushing multimedia content according to this embodiment determines the multimedia content matching associated multimedia content of a user from a multimedia content database, and adds the multimedia content to a recommended multimedia content set, thus realizing pushing multimedia contents with more pertinence.

In some optional modes of implementing this embodiment, the step 440 may further include:

Step 441, determining the multimedia content matching the associated multimedia content of the user from the multimedia content database based on an approximate nearest neighbor search algorithm.

In some application scenarios, for example, word vector conversion (for example, word2vec conversion) of each multimedia content in historical multimedia playlists may be implemented. Specifically, a word and document matrix may be established using each historical multimedia playlist as a document, and using each multimedia content in the historical multimedia playlist as a word in the document. Each component in the matrix may be obtained by statistical-based analysis of the number of co-occurrences of every two words in the document consisting of historical multimedia playlists. After obtaining a vector corresponding to each multimedia content, the multimedia content matching associated multimedia content of a user maybe determined from a multimedia content database based on an approximate nearest neighbor (ANN) search algorithm. For example, by calculating a distance between two vectors, the smaller the distance is, the higher the similarity between multimedia contents indicated by the two vectors is.

Alternatively, a similarity between the multimedia content in a multimedia content database and associated multimedia content of a user may also be predicted by a pre-established and pre-trained neural network model.

By using the ANN algorithm, the multimedia content including a similarity greater than the similarity threshold in a multimedia content database maybe used as the multimedia content matching associated multimedia content of a user. Or, multimedia contents in a multimedia content database may also be ordered by similarity to the associated multimedia content in a descending order, and the first to the N-th multimedia contents are filtered from the ordered multimedia content sequence as the multimedia contents matching the associated multimedia content of the user.

In some optional modes of implementing the embodiments of the disclosure, after the filtering the candidate multimedia content set to obtain a recommended multimedia content set in the step 230 and the step 430, the method may further include:

ordering recommended multimedia contents for playing in the recommended multimedia content set based on an attenuation factor of the recommended multimedia contents for playing in the recommended multimedia content set.

Here, the attenuation factor, e.g., may be determined based on at least one of the following items: a number of playing times of each of the recommended multimedia contents in a predetermined historical period; and a playing moment of each of the recommended multimedia contents in a predetermined historical period.

For example, in some application scenarios, the multimedia content in a recommended multimedia content set has been listened to or watched by a user many times in a recent period, and then attenuation factor value of the multimedia content may be increased, so as to move the ranking of the multimedia content backward in the recommended multimedia content set.

Alternatively, in some other application scenarios, the multimedia content in a recommended multimedia content set has just been listened to or watched by a user, and then attenuation factor value of the multimedia content may be increased, so as to move the ranking of the multimedia content backward in the recommended multimedia content set.

Similarly, the multimedia content in a recommended multimedia content set has not been listened to or watched by a user in a recent period, and then attenuation factor value of the multimedia content may be reduced, so as to move the ranking of the multimedia content forward in the recommended multimedia content set.

Thus, by adjusting the playing sequence of multimedia contents in a recommended multimedia content set, the recommended multimedia content set after adjusting the playing sequence better complies with a user's preference, thus realizing pushing multimedia contents with more pertinence.

In some optional modes of implementing the embodiments of the disclosure a historical operation behavior of the user to the multimedia content may further include emotionally negatively biased operation of the user on the multimedia content. In this case, the emotionally negatively biased operation, e.g., may be an operation that can characterize the user's dislike for the multimedia content.

In these optional modes of implementing the embodiment, the filtering the candidate multimedia content set to obtain a recommended multimedia content set in the step 230 and the step 430 may further include:

deleting multimedia content corresponding to a user emotionally negatively biased operation from the candidate multimedia content set.

By deleting the multimedia contents indicated by a user emotionally negatively biased operation from the candidate multimedia content set, the multimedia contents in the generated recommended multimedia content set better comply with a user's preference, thus realizing pushing multimedia contents with more pertinence.

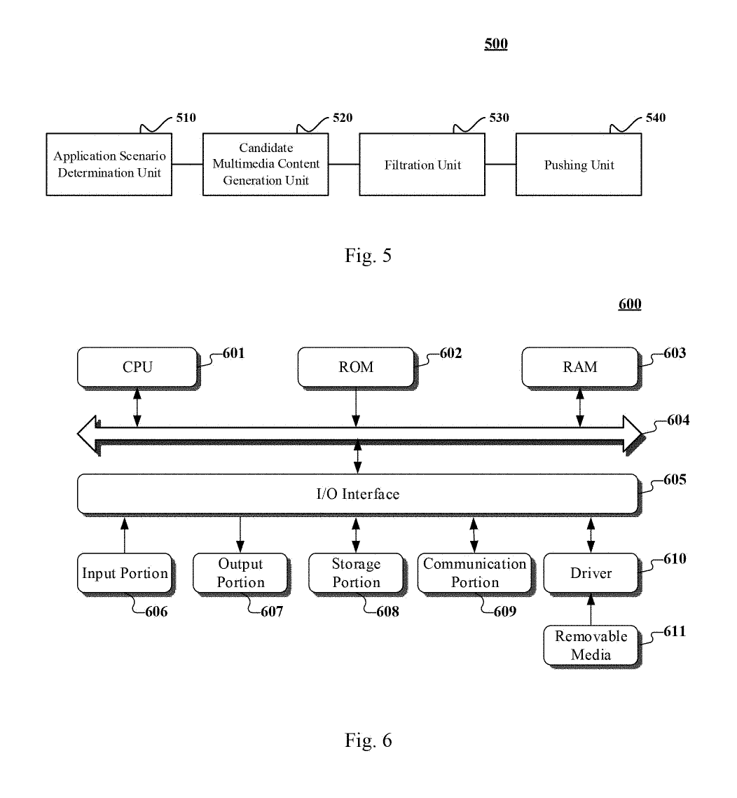

Further referring to FIG. 5, as implementation of the methods shown in the figures, the disclosure provides an embodiment of an apparatus for pushing multimedia content, the embodiment of the apparatus corresponds to the embodiment of the method shown in FIG. 2, and the apparatus may be specifically applied in a variety of electronic devices.

As shown in FIG. 5, an apparatus 500 for pushing multimedia content according to this embodiment includes: an application scenario determination unit 510, a candidate multimedia content generation unit 520, a filtration unit 530 and a pushing unit 540.

The application scenario determination unit 510 may be configured for determining, in response to receiving a request for playing multimedia content, application scenario information for indicating an application scenario where a multimedia playing terminal is located.

The candidate multimedia content generation unit 520 may be configured for determining the multimedia content matching the application scenario from a multimedia content database, and adding the multimedia content to a candidate multimedia content set, the multimedia content database including a scenario index pre-established based on an application scenario.

The filtration unit 530 may be configured for filtering the candidate multimedia content set to obtain a recommended multimedia content set.

The pushing unit 540 may be configured for pushing the recommended multimedia content set to the multimedia playing terminal.

In some optional modes of implementing this embodiment, the application scenario information may include application environment information, and the application environment information may include at least one of following information items:

information for indicating a current moving speed of the multimedia playing terminal; information for indicating current time; information for indicating current weather; and information for indicating a current hot event.

In some optional modes of implementing this embodiment, the application scenario information may further include current state information of a user using the multimedia playing terminal, and the multimedia content playing request includes voice request information inputted by the user.

In these optional modes of implementing this embodiment, the application scenario determination unit 510 may be further configured for: analyzing the voice request information inputted by the user to determine a voice characteristic of the voice request information inputted by the user; and determining the current state information for indicating a current state of the user using the multimedia playing terminal based on the voice characteristic.

In some optional modes of implementing this embodiment, the current state information may include at least one of following information items: information for indicating a current mood of the user; and information for indicating an age of the user. In some optional modes of implementing this embodiment, the request for playing multimedia content include attribute information for indicating an attribute of the multimedia content; the multimedia content database has an attribute index pre-established based on the attribute information of the multimedia content.

In some optional modes of implementing this embodiment, the filtration unit 530 may be further configured for filtering multimedia contents comprised in the candidate multimedia content set based on at least one attribute information indicated by a user preference, wherein the user preference is determined based on a historical operation behavior of the user.

In some optional modes of implementing this embodiment, the apparatus for pushing multimedia content according to this embodiment may further include an associated multimedia matching unit (not shown in the figure).

The associated multimedia matching unit may be configured for determining, before the pushing unit pushes the recommended multimedia content set to the multimedia playing terminal, multimedia content matching associated multimedia content of the user from a multimedia content database, and adding the multimedia content matching the associated multimedia content of the user to the recommended multimedia content set; wherein the associated multimedia content of the user is multimedia content including a positive emotion operation executed thereon by the user.

In some optional modes of implementing this embodiment, the associated multimedia matching unit may be further configured for: determining the multimedia content matching the associated multimedia content of the user from the multimedia content database based on an approximate nearest neighbor search algorithm.

In some optional modes of implementing this embodiment, the apparatus for pushing multimedia content according to this embodiment may further include an ordering unit (not shown in the figure).

The ordering unit may be configured for ordering recommended multimedia contents for playing in the recommended multimedia content set based on an attenuation factor of the recommended multimedia contents for playing in the recommended multimedia content set after the filtration unit filtering the candidate multimedia content set to obtain a recommended multimedia content set; wherein the attenuation factor is determined based on at least one of following items: a number of playing times of each of the recommended multimedia contents in a predetermined historical period; and a playing moment of each of the recommended multimedia contents in a predetermined historical period.

Below referring to FIG. 6, a structural diagram of a computer system 600 of a terminal device/server applicable for implementing the embodiments of the disclosure is shown. The terminal device/server shown in FIG. 6 is only an example, and shall not limit the functions and serviceable range of the embodiments of the disclosure in any way.

As shown in FIG. 6, the computer system 600 includes a central processing unit (CPU) 601, which may execute various appropriate actions and processes in accordance with a program stored in a read-only memory (ROM) 602 or a program loaded into a random access memory (RAM) 603 from a storage portion 608. The RAM 603 also stores various programs and data required by operations of the system 600. The CPU 601, the ROM 602 and the RAM 603 are connected to each other through a bus 604. An input/output (I/O) interface 605 is also connected to the bus 604.

The following components are connected to the I/O interface 605: an input portion 606 including a keyboard, a mouse etc.; an output portion 607 comprising a cathode ray tube (CRT), a liquid crystal display device (LCD), a speaker etc.; a storage portion 608 including a hard disk and the like; and a communication portion 609 comprising a network interface card, such as a LAN card and a modem. The communication portion 609 performs communication processes via a network, such as the Internet. A driver 610 is also connected to the I/O interface 605 as required. A removable medium 611, such as a magnetic disk, an optical disk, a magneto-optical disk, and a semiconductor memory, may be installed on the driver 610, to facilitate the retrieval of a computer program from the removable medium 611, and the installation thereof on the storage portion 608 as needed.

In particular, according to an embodiment of the present disclosure, the process described above with reference to the flow chart maybe implemented in a computer software program. For example, an embodiment of the present disclosure includes a computer program product, which comprises a computer program that is tangibly embedded in a machine-readable medium. The computer program comprises program codes for executing the method as illustrated in the flowchart. In such an embodiment, the computer program may be downloaded and installed from a network via the communication portion 609, and/or may be installed from the removable media 611. The computer program, when executed by the central processing unit (CPU) 601, implements the above mentioned functionalities as defined by the methods of the present application. It needs to be noted that the computer readable medium in the present disclosure may be computer readable signal medium or computer readable storage medium or a combination thereof. An example of the computer readable storage medium may include but not limited to: systems, apparatus or elements of electric, magnet, optical, electromagnet, infrared ray, or semiconductor or a combination thereof. A more specific example of the computer readable storage medium may include but is not limited to: electrical connection with one or more wire, a portable computer disk, a hard disk, a random access memory (RAM), a read only memory (ROM), an erasable programmable read only memory (EPROM or flash memory), a fibre, a portable compact disk read only memory (CD-ROM), an optical memory, a magnet memory or a combination thereof. In the present disclosure, the computer readable storage medium may be any physical medium containing or storing programs which can be used by a command execution system, apparatus or element or the incorporation thereof. In the present disclosure, the computer readable signal medium may include data signal in the base band or propagating as parts of a carrier in which computer readable program codes are carried. The propagated signal may take various forms, include but is not limited to: an electromagnetic signal, an optical signal or a combination thereof. The signal medium that can be read by computer may be any computer readable medium except for the computer readable storage medium. The computer readable medium is capable of transmitting, propagating or transferring programs for used by or used in combination with a command execution system, apparatus or element. The program codes contained on the computer readable medium may be transmitted with any suitable medium including but is not limited to: a wireless medium, a wired medium, an optical cable medium, a RF medium and the like, or any combination thereof.

A computer program code for executing operations in the disclosure may be compiled using one or more programming languages or combinations thereof. The programming languages include object-oriented programming languages, such as Java, Smalltalk or C++, and also include conventional procedural programming languages, such as “C” language or similar programming languages. The program code may be completely executed on a user's computer, partially executed on a user's computer, executed as a separate software package, partially executed on a user's computer and partially executed on a remote computer, or completely executed on a remote computer or server. In the circumstance involving a remote computer, the remote computer may be connected to a user's computer through any network, including local area network (LAN) or wide area network (WAN), or may be connected to an external computer (for example, connected through Internet using an Internet service provider).

The flowcharts and block diagrams in the figures illustrate architectures, functions and operations that may be implemented according to the system, the method and the computer program product of the various embodiments. In this regard, each block in the flow charts and block diagrams may represent a module, a program segment, or a code portion. The module, the program segment, or the code portion comprises one or more executable instructions for implementing the specified logical function. It should be noted that, in some alternative implementations, the functions denoted by the blocks may occur in a sequence different from the sequences shown in the figures. For example, in practice, two blocks in succession may be executed, depending on the involved functionalities, substantially in parallel, or in a reverse sequence. It should also be noted that, each block in the block diagrams and/or the flow charts and/or a combination of the blocks may be implemented by a dedicated hardware-based system executing specific functions or operations, or by a combination of a dedicated hardware and computer instructions.

The units or modules involved in the embodiments of the present application may be implemented by way of software or hardware. The described units or modules may also be provided in a processor, for example, described as: a processor, comprising an application scenario determination unit, a candidate multimedia content generation unit, a filtration unit and a pushing unit, where the names of these units or modules are not considered as a limitation to the units or modules. For example, the application scenario determination unit may also be described as “a unit for “determining, in response to receiving a request for playing multimedia content, application scenario information for indicating an application scenario where a multimedia playing terminal is located.”

In another aspect, the present application further provides a non-volatile computer storage medium. The non-volatile computer storage medium may be the non-volatile computer storage medium included in the apparatus in the above embodiments, or a stand-alone non-volatile computer storage medium which has not been assembled into the apparatus. The non-volatile computer storage medium stores one or more programs. The one or more programs, when executed by a device, cause the device to: determine, in response to receiving a request for playing multimedia content, application scenario information for indicating an application scenario where a multimedia playing terminal is located; determine the multimedia content matching the application scenario from a multimedia content database, and add the multimedia content to a candidate multimedia content set, the multimedia content database including a scenario index pre-established based on an application scenario; filter the candidate multimedia content set to obtain a recommended multimedia content set; and push the recommended multimedia content set to the multimedia playing terminal.

The foregoing is only a description of the preferred embodiments of the present application and the applied technical principles. It should be appreciated by those skilled in the art that the inventive scope of the present application is not limited to the technical solutions formed by the particular combinations of the above technical features. The inventive scope should also cover other technical solutions formed by any combinations of the above technical features or equivalent features thereof without departing from the concept(s) of the disclosure, such as, technical solutions formed by replacing the features as disclosed in the present application with (but not limited to), technical features with similar functions.

What is claimed is:

1. A method for pushing multimedia content, the method comprising:
determining, in response to receiving a request for playing multimedia content, application scenario information for indicating an application scenario where a multimedia playing terminal is located;
determining the multimedia content matching the application scenario from a multimedia content database, and adding the multimedia content to a candidate multimedia content set, the multimedia content database including a scenario index pre-established based on an application scenario;
filtering the candidate multimedia content set to obtain a recommended multimedia content set; and
pushing the recommended multimedia content set to the multimedia playing terminal,
wherein the method is performed by at least one processor.

2. The method according to claim 1, wherein the application scenario information comprises application environment information, and the application environment information comprises at least one of following information items:
information for indicating a current moving speed of the multimedia playing terminal;
information for indicating current time;
information for indicating current weather; and
information for indicating a current hot event.

3. The method according to claim 1, wherein the application scenario information comprises current state information of a user using the multimedia playing terminal, and the request for playing multimedia content comprises voice request information inputted by the user; and
the determining, in response to receiving a request for playing multimedia content, application scenario information for indicating an application scenario where a multimedia playing terminal is located comprises:
analyzing the voice request information inputted by the user to determine a voice characteristic of the voice request information inputted by the user; and
determining the current state information for indicating a current state of the user using the multimedia playing terminal based on the voice characteristic.

4. The method according to claim 3, wherein the current state information comprises at least one of following information items:
information for indicating a current mood of the user; and
information for indicating an age of the user.

5. The method according to claim 1, wherein the request for playing multimedia content comprises attribute information for indicating an attribute of the multimedia content; the multimedia content database has an attribute index pre-established based on the attribute information of the multimedia content; and
the filtering the candidate multimedia content set to obtain a recommended multimedia content set comprises:
filtering multimedia contents comprised in the candidate multimedia content set based on at least one attribute information indicated by a user preference, wherein the user preference is determined based on a historical operation behavior of the user.

6. The method according to claim 1, before pushing the recommended multimedia content set to the multimedia playing terminal, the method further comprising:
determining multimedia content matching associated multimedia content of the user from a multimedia content database, wherein the associated multimedia content of the user is multimedia content including a positive emotion operation executed thereon by the user; and
adding the multimedia content matching the associated multimedia content of the user to the recommended multimedia content set.

7. The method according to claim 6, wherein the determining multimedia content matching associated multimedia content of the user from a multimedia content database comprises:
determining the multimedia content matching the associated multimedia content of the user from the multimedia content database based on an approximate nearest neighbor search algorithm.

8. The method according to claim 1, after the filtering the candidate multimedia content set to obtain a recommended multimedia content set, the method further comprising:
ordering recommended multimedia contents for playing in the recommended multimedia content set based on an attenuation factor of the recommended multimedia contents for playing in the recommended multimedia content set;
wherein the attenuation factor is determined based on at least one of following items:
a number of playing times of each of the recommended multimedia contents in a predetermined historical period; and
a playing moment of each of the recommended multimedia contents in a predetermined historical period.

9. The method according to claim 1, wherein the filtering the candidate multimedia content set to obtain a recommended multimedia content set comprises:
deleting multimedia content corresponding to a user emotionally negatively biased operation from the candidate multimedia content set.

10. An apparatus for pushing multimedia content, the apparatus comprising:
at least one processor; and
a memory storing instructions, which when executed by the at least one processor, cause the at least one processor to perform operations, the operations comprising:
determining, in response to receiving a request for playing multimedia content, application scenario information for indicating an application scenario where a multimedia playing terminal is located;
determining the multimedia content matching the application scenario from a multimedia content database, and adding the multimedia content to a candidate multimedia content set, the multimedia content database including a scenario index pre-established based on an application scenario;
filtering the candidate multimedia content set to obtain a recommended multimedia content set; and
pushing the recommended multimedia content set to the multimedia playing terminal.

11. The apparatus according to claim 10, wherein the application scenario information comprises application environment information, and the application environment information comprises at least one of following information items:
information for indicating a current moving speed of the multimedia playing terminal;
information for indicating current time;
information for indicating current weather; and
information for indicating a current hot event.

12. The apparatus according to claim 10, wherein the application scenario information comprises current state information of a user using the multimedia playing terminal, and the request for playing multimedia content comprises voice request information inputted by the user; and
the determining, in response to receiving a request for playing multimedia content, application scenario information for indicating an application scenario where a multimedia playing terminal is located comprises:
analyzing the voice request information inputted by the user to determine a voice characteristic of the voice request information inputted by the user; and
determining the current state information for indicating a current state of the user using the multimedia playing terminal based on the voice characteristic.

13. The apparatus according to claim 12, wherein the current state information comprises at least one of following information items:
information for indicating a current mood of the user; and
information for indicating an age of the user.

14. The apparatus according to claim 10, wherein the request for playing multimedia content comprises attribute information for indicating an attribute of the multimedia content; the multimedia content database has a an attribute index pre-established based on the attribute information of the multimedia content; and
the filtering the candidate multimedia content set to obtain a recommended multimedia content set comprises:
filtering multimedia contents comprised in the candidate multimedia content set based on at least one attribute information indicated by a user preference, wherein the user preference is determined based on a historical operation behavior of the user.

15. The apparatus according to claim 10, before pushing the recommended multimedia content set to the multimedia playing terminal, the operations further comprising:
determining multimedia content matching associated multimedia content of the user from a multimedia content database, and adding the multimedia content matching the associated multimedia content of the user to the recommended multimedia content set;
wherein the associated multimedia content of the user is multimedia content including a positive emotion operation executed thereon by the user.

16. The apparatus according to claim 15, wherein the determining multimedia content matching associated multimedia content of the user from a multimedia content database comprises:
determining the multimedia content matching the associated multimedia content of the user from the multimedia content database based on an approximate nearest neighbor search algorithm.

17. The apparatus according to claim 10, after the filtering the candidate multimedia content set to obtain a recommended multimedia content set, the operations further comprising:
ordering recommended multimedia contents for playing in the recommended multimedia content set based on an attenuation factor of the recommended multimedia contents for playing in the recommended multimedia content set;
wherein the attenuation factor is determined based on at least one of following items:
a number of playing times of each of the recommended multimedia contents in a predetermined historical period; and
a playing moment of each of the recommended multimedia contents in a predetermined historical period.

18. The apparatus according to claim 10, wherein the filtering the candidate multimedia content set to obtain a recommended multimedia content set comprises:
deleting multimedia content corresponding to a user emotionally negatively biased operation from the candidate multimedia content set.

19. A non-transitory computer storage medium storing computer programs, which when executed by a processor, cause the processor to perform operations, the operations comprising:
determining, in response to receiving a request for playing multimedia content, application scenario information for indicating an application scenario where a multimedia playing terminal is located;
determining the multimedia content matching the application scenario from a multimedia content database, and adding the multimedia content to a candidate multimedia content set, the multimedia content database including a scenario index pre-established based on an application scenario;
filtering the candidate multimedia content set to obtain a recommended multimedia content set; and
pushing the recommended multimedia content set to the multimedia playing terminal.
